(19) United States
(12) Patent Application Publication
(10) Pub. No.: US 2022/0197568 A1
(43) Pub. Date: Jun. 23, 2022

(54) OBJECT INPUT/OUTPUT ISSUE DIAGNOSIS IN VIRTUALIZED COMPUTING ENVIRONMENT

(71) Applicant: VMware, Inc., Palo Alto, CA (US)

(72) Inventors: Yang YANG, Shanghai (CN); Jin FENG, Shanghai (CN); Haitao ZHOU, Shanghai (CN); Jianrong ZHAO, Shanghai (CN)

(73) Assignee: VMware, Inc., Palo Alto, CA (US)

(21) Appl. No.: 17/169,551

(22) Filed: Feb. 8, 2021

(30) Foreign Application Priority Data
Dec. 23, 2020 (CN) PCT/CN2020/138537

(51) Int. Cl. G06F 3/06; G06F 11/34

(52) U.S. Cl. CPC G06F 3/0664; G06F 3/0653; G06F 3/0659; G06F 11/3466; G06F 3/067; G06F 11/3409; G06F 3/0619

(57) ABSTRACT

An example method for diagnosing an input/output (I/O) issue associated with an object owned by the first host in a vSAN cluster is disclosed. The method includes identifying a first component and a second component of the object. In response to the first component being locally stored on the first host, the methods include collecting a first set of I/O aggregated statistic information. In response to the second component being remotely stored on the second host, the methods include issuing a command to the second host, obtaining a second set of I/O aggregated statistic information from the second host and network metrics associated with the first host and the second host. The methods include diagnosing the I/O issue associated with the object based on the first and second sets of I/O aggregated statistic information and the network metrics.

### CROSS-REFERENCE TO RELATED APPLICATION

The present application claims the benefit of Patent Cooperation Treaty (PCT) Application No. PCT/CN2020/138537, filed Dec. 23, 2020. The PCT application is herein incorporated by reference in its entirety.

### BACKGROUND

Unless otherwise indicated herein, the approaches described in this section are not admitted to be prior art by inclusion in this section.

A virtualization software suite (vSphere Suite) for implementing and managing virtual infrastructures in a virtualized computing environment may include a hypervisor (ESXi) that implements virtual machines (VMs) on physical hosts, a virtual storage area network (vSAN) software that aggregates local storage to form a shared datastore for a cluster of physical hosts, and a server management software (vCenter) that centrally provisions and manages virtual datacenters, VMs, hosts, clusters, datastores, and virtual networks.

The vSAN software uses the concept of a disk group as a container for solid-state drives (SSDs) and non-SSDs, such as hard disk drives (HDDs). On each host (node) in a vSAN cluster, the local drives of the host are organized into one or more disk groups. Each disk group includes one SSD that serves as read cache and write buffer (e.g., a cache tier), and one or more SSDs or non-SSDs that serve as permanent storage (e.g., a capacity tier). The aggregate of the disk groups from all the nodes form a vSAN datastore distributed and shared across the nodes of the vSAN cluster.

The vSAN software stores and manages data in the form of data containers called objects. An object is a logical volume that has its data and metadata distributed across a vSAN cluster. For example, every virtual machine disk (VMDK) is an object, as is every snapshot. For namespace objects, the vSAN software leverages virtual machine file system (VMFS) as the file system to store files within the namespace objects. A virtual machine (VM) is provisioned on a vSAN datastore as a VM home namespace object, which stores metadata files of the VM including descriptor files for the VM's VMDKs.

Health and performance services of the virtualization software suite were developed to monitor health and performance problems of components in the vSAN cluster. However, these services are not adequate to identify causes of such problems. More specifically, these services cannot accurately diagnose complicated input/output issues associated with objects in the vSAN cluster.

### BRIEF DESCRIPTION OF DRAWINGS

FIG. 1 is a schematic diagram illustrating an example virtualized computing environment to diagnose an input/output issue associated with an object in the virtualized computing environment;

FIG. 2 is a schematic diagram illustrating an example system to diagnose a I/O issue associated with an object in a virtualized computing environment; and

FIG. 3 is a flowchart of an example process of an object owner to diagnose a I/O issue associated with the object in a virtualized computing environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

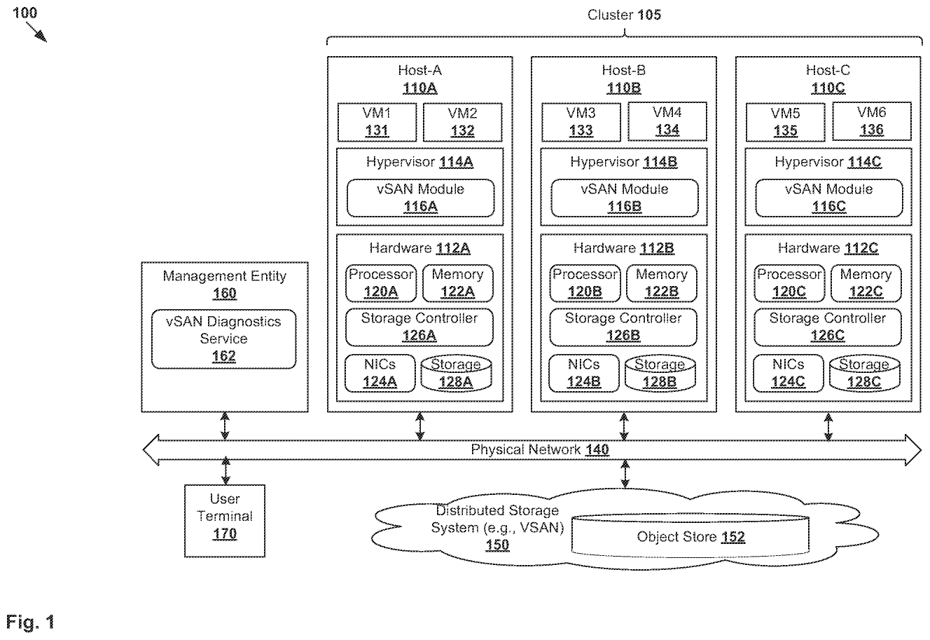

Challenges relating to diagnose an input/output issue associated with an object in a virtualized computing environment will now be explained in more detail using FIG. 1, which is a schematic diagram illustrating example virtualized computing environment 100. It should be understood that, depending on the desired implementation, virtualized computing environment 100 may include additional and/or alternative components than that shown in FIG. 1.

In the example in FIG. 1, virtualized computing environment 100 includes cluster 105 of multiple hosts, such as Host-A 110A, Host-B 110B, and Host-C 110C. In the following, reference numerals with a suffix “A” relates to Host-A 110A, suffix “B” relates to Host-B 110B, and suffix “C” relates to Host-C 110C. Although three hosts (also known as “host computers”, “physical servers”, “server systems”, “host computing systems”, etc.) are shown for simplicity, cluster 105 may include any number of hosts. Although one cluster 105 is shown for simplicity, virtualized computing environment 100 may include any number of clusters.

Each host 110A/110B/110C in cluster 105 includes suitable hardware 112A/112B/112C and executes virtualization software such as hypervisor 114A/114B/114C to maintain a mapping between physical resources and virtual resources assigned to various virtual machines. For example, Host-A 110A supports VM1 131 and VM2 132; Host-B 110B supports VM3 133 and VM4 134; and Host-C 110C supports VM5 135 and VM6 136. In practice, each host 110A/110B/110C may support any number of virtual machines, with each virtual machine executing a guest operating system (OS) and applications. Hypervisor 114A/114B/114C may also be a “type 2” or hosted hypervisor that runs on top of a conventional operating system (not shown) on host 110A/110B/110C.

Although examples of the present disclosure refer to “virtual machines,” it should be understood that a “virtual machine” running within a host is merely one example of a “virtualized computing instance” or “workload.” A virtualized computing instance may represent an addressable data compute node or isolated user space instance. In practice, any suitable technology may be used to provide isolated user space instances, not just hardware virtualization. Other virtualized computing instances may include containers (e.g., running on top of a host operating system without the need for a hypervisor or separate operating system such as Docker, etc.; or implemented as an operating system level virtualization), virtual private servers, client computers, etc. The virtual machines may also be complete computation environments, containing virtual equivalents of the hardware and software components of a physical computing system.

Hardware 112A/112B/112C includes any suitable components, such as processor 120A/120B/120C (e.g., central processing unit (CPU)); memory 122A/122B/122C (e.g., random access memory); network interface controllers (NICs) 124A/124B/124C to provide network connection; storage controller 126A/126B/126C that provides access to storage resources 128A/128B/128C, etc. Corresponding to hardware 112A/112B/112C, virtual resources assigned to each virtual machine may include virtual CPU, virtual memory, virtual machine disk(s), virtual NIC(s), etc.

Storage controller 126A/126B/126C may be any suitable controller, such as redundant array of independent disks (RAID) controller, etc. Storage resource 128A/128B/128C may represent one or more disk groups. In practice, each disk group represents a management construct that combines one or more physical disks, such as hard disk drive (HDD), solid-state drive (SSD), solid-state hybrid drive (SSHD), peripheral component interconnect (PCI) based flash storage, serial advanced technology attachment (SATA) storage, serial attached small computer system interface (SAS) storage, Integrated Drive Electronics (IDE) disks, Universal Serial Bus (USB) storage, etc.

Through storage virtualization, hosts 110A-110C in cluster 105 aggregate their storage resources 128A-128C to form distributed storage system 150, which represents a shared pool of storage resources. For example in FIG. 1, Host-A 110A, Host-B 110B and Host-C 110C aggregate respective local physical storage resources 128A, 128B and 128C into object store 152 (also known as a datastore or a collection of datastores). In this case, data (e.g., virtual machine data) stored on object store 152 may be placed on, and accessed from, one or more of storage resources 128A-128C. In practice, distributed storage system 150 may employ any suitable technology, such as Virtual Storage Area Network (vSAN) from VMware, Inc. Cluster 105 may be referred to as a vSAN cluster.

In virtualized computing environment 100, management entity 160 provides management functionalities to various managed objects, such as cluster 105, hosts 110A-110C, virtual machines 131-136, etc. Management entity 160 may include vSAN diagnostic service 162. In response to receiving a diagnostic service request from user terminal 170, vSAN diagnostic service 162 is configured to manage vSAN modules 116A, 1168 and 116C in virtualized computing environment 100 to fulfill the vSAN diagnostic service request.

Conventionally, in response to a vSAN health check request from user terminal 170, management entity 160 is configured to query vSAN health services (e.g., vsanmgmtd) in vSAN modules 116A, 1168 and 116C and generate a vSAN health report based on statistics collected by vSAN health services in vSAN modules 116A, 1168 and 116C. The vSAN health report may indicate problems of vSAN cluster 150 by different categories. For example, the vSAN health report may categorize problems of vSAN cluster 150. Some example categories may include, without limitation, hardware compatibility, performance service, network, physical disk, etc. In contrast, the conventional vSAN health report cannot identify the correlations among different categories because the collected statistics are limited. For example, the vSAN health report may indicate a performance service problem (e.g., a slow input/output (I/O) associated with an object), but fail to identify whether the slow I/O is correlated to a hardware failure (e.g., error of a physical network interface controller) or a software configuration error (e.g., a network configuration error).

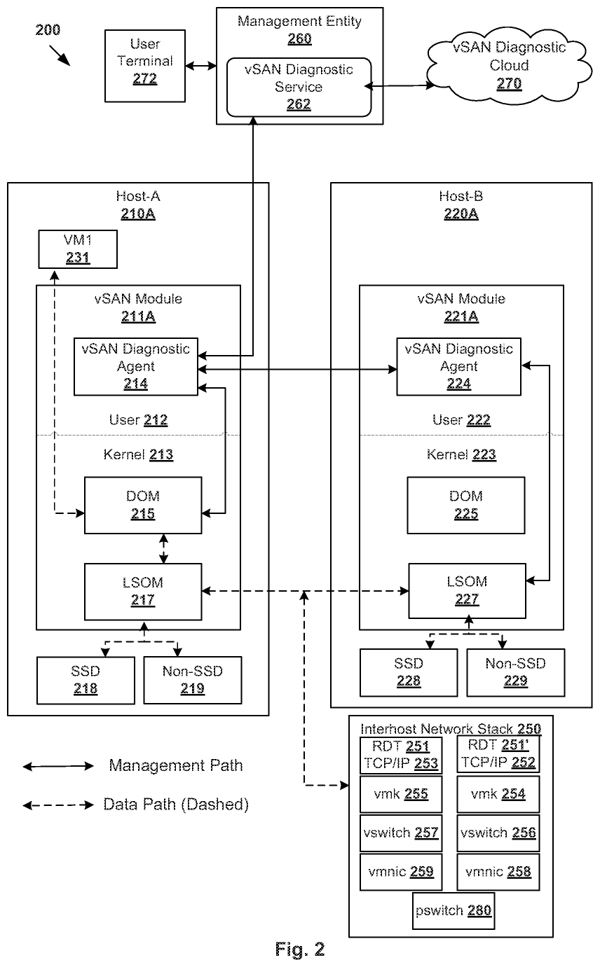

FIG. 2 is a schematic diagram illustrating an example system 200 to diagnose a I/O issue associated with an object in a virtualized computing environment. In some embodiments, system 200 include management entity 260, vSAN diagnostic cloud 270, user terminal 272, host-A 210A, host-B 210B, SSD 218 and 228, and non-SSD 219 and 229. In some embodiments, in conjunction with FIG. 1, management entity 260 corresponds to management entity 160, host-A 210A and host-B 210B correspond to host-A 110A and host-B 110B, respectively, SSD 218 and non-SSD 219 correspond to storage 128A, and SSD 228 and non-SSD 229 correspond to storage 128B.

In some embodiments, management entity 260 may implement vSAN diagnostic service 262. vSAN diagnostic service 262 is configured to obtain diagnostic specific information from vSAN diagnostic agent 214 and 224. vSAN diagnostic service 262 may be also configured to communicate with vSAN diagnostic cloud 270 to obtain updated diagnostic thresholds from vSAN diagnostic cloud 270, push the updated diagnostic thresholds to vSAN diagnostic agents 214/224 and upload diagnostic logs to vSAN diagnostic cloud 270. vSAN diagnostic service 262 may be configured to interact with other modules implemented by management entity 260 to persist configurations, manage alarms and display diagnostic results.

In some embodiments, vSAN module 211A includes vSAN diagnostic agent 214 in its user space 212. vSAN module 211A may further include distributed object manager (DOM) 215 and log-structured object manager (LSOM) 217 in its kernel space 213. Similarly, vSAN module 221A includes vSAN diagnostic agent 224 in its user space 222. vSAN module 221A may further include DOM 225 and LSOM 227 in its kernel space 223. The vSAN diagnostic agent in the user space and the DOM/LSOM in the kernel space are for illustration purposes only. In some other embodiments, vSAN diagnostic agent 214, DOM 215 and LSOM 217 may be in a first same space, instead of separated user space 212 and kernel space 213. Similarly, vSAN diagnostic agent 214, DOM 215 and LSOM 217 may be in a second same space, instead of separated user space 222 and kernel space 223.

In some embodiments, DOM 215 is configured to create components and distribute them across a vSAN cluster including host-A 210A and host-B 210B. After a DOM object is created from a set of components across the cluster, one of nodes (e.g., host-A 210A) in the vSAN cluster is nominated as the DOM owner for that DOM object. The DOM owner handles all input/output operations per second (10PS) to that DOM object by locating the set of components across the vSAN cluster and redirecting the I/O to respective components. Similarly, DOM 225 may also be configured to create components and distribute them across the cluster.

In some embodiments, DOM 215 is configured to create components for a DOM object and distribute the components to LSOM 217 and LSOM 227. LSOM 217 is configured to locally store the data on SSD 218 or non-SSD 219 of host-A 210A as one or more LSOM objects, which may correspond to components of the DOM object. Similarly, LSOM 227 is configured to locally store the data on SSD 228 or non-SSD 229 of host-B 220A as one or more LSOM objects, which may correspond to components of the DOM object.

In some embodiments, DOM 215 is configured to redirect the I/O to the DOM object to SSD 218 or non-SSD 219 locally or to SSD 228 or non-SSD 229 remotely through interhost network stack 250. In some embodiments, interhost network stack 250 includes, but not limited to, Reliable Datagram Transport (RDT) 251, Transmission Control Protocol/Internet Protocol (TCP/IP) 253, VMKernel NIC (vmk) 255, virtual switch (vswitch) 257, VMNetwork Interface Controller (vmnic) 259 associated with host-A 210A and RDT 251′, TCP/IP 252, vmk 254, vswitch 256, vmnic 258 associated with host-B 210B, and physical switch (pswitch) 280 interfaced between vmnic 258 and vmnic 259.

In some embodiments, vSAN diagnostic agent 214 implemented on host-A 210A is configured to access information specific to host-A 210A, such as I/O information in kernel space 213 of host-A 210A. Such information may include, but not limited to, I/O information associated with DOM 215, LSOM 217, SSD 218, non-SSD 219, RDT 251, TCP/IP 253, vmk 255, vswitch 257, vmnic 259 and pswitch 280. Similarly, vSAN diagnostic agent 224 implemented on host-B 210B is configured to access information specific to host-B 210B, such as I/O information in kernel space 223 of host-B 210B. Such information may include, but not limited to, I/O information associated with DOM 225, LSOM 227, SSD 228, non-SSD 229, RDT 251′, TCP/IP 252, vmk 254, vswitch 256, vmnic 258 and pswitch 280.

Compared to conventional approaches set forth above, in some embodiments, vSAN diagnostic agent 214 is configured to collect additional statistics, for example, from kernel space 213 and vSAN diagnostic agent 224 is configured to collect additional statistics, for example, from kernel space 223. In some embodiments, vSAN diagnostic service 262, in conjunction with vSAN diagnostic agent 214 and vSAN diagnostic agent 224, may diagnose or identify correlations of issues of a component in the vSAN cluster to a level of specific network configurations or physical network components.

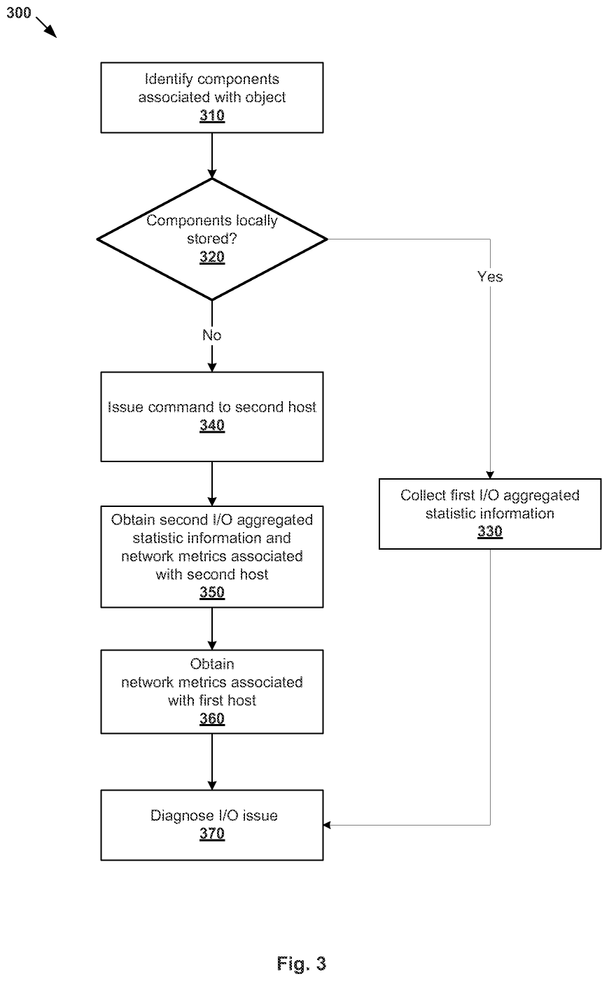

In more detail, in conjunction with FIG. 2, FIG. 3 is a flowchart of example process 300 of first host 210-A to diagnose a I/O issue associated with an object owned by first host 210-A in a vSAN cluster including first host 210-A and second host 220-A. Example process 300 may include one or more operations, functions, or actions illustrated by one or more blocks, such as 310 to 370. The various blocks may be combined into fewer blocks, divided into additional blocks, and/or eliminated depending on the desired implementation.

In some embodiments, in conjunction with FIG. 2, in response to a request to diagnose I/O issues associated with an object in a vSAN cluster received from user terminal 272, vSAN diagnostic service 262 is configured to query management modules (not shown) on management entity 260 to identify the owner of the object. In some embodiments, after the object (e.g., a DOM object) is created from a set of components across the vSAN cluster, a host (e.g., first host, host-A 210A) in the vSAN cluster is nominated as the owner of the object. This owner-object information is stored in the management modules. The owner handles input/output operations to the object. In some embodiments, host-A 210A is identified as the owner of the object and vSAN diagnostic service 262 is configured to call vSAN diagnostic agent 214 on host-A 210A to diagnose I/O issues associated with the object.

In some embodiments, an example object may be a virtual machine disk assigned to VM 231 supported by host-A 210A. Alternatively, the object may be a virtual machine disk assigned to another virtual machine supported by another host. Moreover, the object may be a disk of iSCSI service or a backing object of a file share.

At 310 in FIG. 3, in conjunction with FIG. 2, vSAN diagnostic agent 214 is in user space 212 of host-A 210A. Given DOM 215 is configured to create components for the object and distribute the components across the vSAN, in some embodiments, vSAN diagnostic agent 214 is configured to obtain components associated with the object from DOM 215 in kernel space 213 of host-A 210A. For example, DOM 215 may identify a first component and a second component associated with the object. Block 310 may be followed by block 320.

At 320 in FIG. 3, in conjunction with FIG. 2, vSAN diagnostic agent 214 is configured to determine whether the first component is locally stored (e.g., SSD 218 or non-SSD 219) on host-A 210A based on information received from DOM 215. In addition, vSAN diagnostic agent 214 is also configured to determine whether the second component is remotely stored (e.g., SSD 228 or non-SSD 229) on host-B 210B based on information received from DOM 215. In response to vSAN diagnostic agent 214 determines that the first component is locally stored on host-A 210A, block 320 may be followed by block 330.

At block 330, vSAN diagnostic agent 214 is configured to collect a first set of I/O aggregated statistic information associated with the first component. In some embodiments, vSAN diagnostic agent 214 is configured to collect a first set of I/O aggregated statistic information from a first trace file stored on host-A 210A through a pathway between user space 212 and kernel space 213. In some embodiments, the first set of I/O aggregated statistic information includes, but not limited to, a first latency and a second latency.

In some embodiments, DOM 215 is configured to obtain the first latency. The first latency may be associated with an overall latency of the object.

In some embodiments, LSOM 217 is configured to obtain the second latency. The second latency is associated with a storage resource (e.g., SSD 218 and/or non-SSD 219) constraint of host-A 210A. In some embodiments, the second latency includes, but not limited to, a latency in a cache tier (e.g., SSD 218) of a disk group on host-A 210A to complete the I/O back to DOM 215 and another latency between the cache tier and a capacity tier (e.g., non-SSD 219) of the disk group on host-A 210A.

In some embodiments, a I/O request associated with the object is assigned with a unique identifier. DOM 215 is configured to record a first timestamp of receiving the I/O request and a second timestamp of completing the I/O request. Similarly, LSOM 217 is configured to record a third timestamp of receiving the I/O request and a fourth timestamp of completing the I/O request. SSD 218 is configured to record a fifth timestamp of receiving the I/O request and a sixth timestamp of completing the I/O request. In addition, non-SSD 219 is configured to record a seventh timestamp of receiving the I/O request and an eighth timestamp of completing the I/O request.

In some embodiments, the first latency may correspond to a difference of the first timestamp and the second timestamp. The second latency may correspond to a difference of the third timestamp and the fourth timestamp. The latency in the cache tier may correspond to a difference of the fifth timestamp and the sixth timestamp. The latency between the cache tier and the capacity tier may correspond to a difference of the seventh timestamp and the eighth timestamp.

In some embodiments, the timestamps and the unique identifier are pushed to a queue which is configured to asynchronously process the timestamps and the unique identifier (e.g., correlating the timestamps and the unique identifier) and dump a processed result to the first trace file stored on host-A 210A. Processed results may be aggregated to form I/O aggregated statistic information, such as the first set of I/O aggregated statistic information.

In response to vSAN diagnostic agent 214 determines that the second component is remotely stored on host-B 210B, block 320 may be followed by block 340.

In conjunction with FIG. 2, given that the second component is remotely stored on host-B 210B, vSAN diagnostic agent 214 is not able to access I/O information associated with the second component from kernel space 223 of host-B 210B. At block 340, vSAN diagnostic agent 214 is configured to issue a command to vSAN diagnostic agent 224. In some embodiments, the command includes the unique identifier assigned to the I/O request. In some embodiments, the command is transmitted through an application program interface between vSAN module 211A and vSAN module 221A, more specifically between vSAN diagnostic agent 214 and vSAN diagnostic agent 224.

Block 340 may be followed by block 350. At block 350, in response to receiving the command, vSAN diagnostic agent 224 is configured to collect a second set of I/O aggregated statistic information associated with the second component from a second trace file stored on host-B 220A through a pathway between user space 222 and kernel space 223. In some embodiments, the second set of I/O aggregated statistic information includes, but not limited to, a third latency.

In some embodiments, LSOM 227 is configured to obtain the third latency. The third latency is associated with a storage resource (e.g., SSD 228 and/or non-SSD 229) constraint of host-B 220A. In some embodiments, the third latency includes, but not limited to, a latency in a cache tier (e.g., SSD 228) of a disk group on host-B 220A to complete the I/O back to LSOM 217 and another latency between the cache tier and a capacity tier (e.g., non-SSD 229) of the disk group on host-B 220A.

In some embodiments, LSOM 227 is configured to record a ninth timestamp of receiving the I/O request and a tenth timestamp of completing the I/O request. SSD 228 is configured to record a eleventh timestamp of receiving the I/O request and a twelfth timestamp of completing the I/O request. In addition, non-SSD 219 is configured to record a thirteenth timestamp of receiving the I/O request and a fourteenth timestamp of completing the I/O request.

In some embodiments, the third latency may correspond to a difference of the ninth timestamp and the tenth timestamp. The latency in the cache tier (e.g., SSD 228) may correspond to a difference of the eleventh timestamp and the twelfth timestamp. The latency between the cache tier (e.g., SSD 228) and the capacity tier (e.g., non-SSD 229) may correspond to a difference of the thirteenth timestamp and the fourteenth timestamp.

In some embodiments, the timestamps and the unique identifier assigned to the I/O request are pushed to a queue which is configured to asynchronously process the timestamps and the unique identifier (e.g., correlating the timestamps and the unique identifier) and dump a processed result to the second trace file stored on host-B 220A. Processed results may be aggregated to form I/O aggregated statistic information, such as the second set of I/O aggregated statistic information.

In some embodiments, because the second component is remotely stored on host-B 220A, the I/O request is transmitted to LSOM 227 on host-B 220A through interhost network stack 250. For example, the I/O request may be processed through virtual and physical network stacks of RDT 251, TCP/IP 253, vmk 255, vswitch 257 and vmnic 259 associated with host-A 210A, pswitch 280, and virtual and physical network stacks of vmnic 258, vswitch 256, vmk 254, TCP/IP 252 and RDT 251′ associated with host-B 220A. In some embodiments, vSAN diagnostic agent 224 is further configured to collect network metrics of virtual and hardware stacks RDT 251′, TCP/IP 252, vmk 254, vswitch 256 and vmnic 258 associated with host-B 220A at block 350. In some embodiments, the network metrics may include, but not limited to, cyclic redundance check metric, transmit carrier metric, and flapping metrics in vmnic 258 stack, duplicated addresses in vmk 254 stack, and TCP fast retransmission metric and TCP zero frame metric in TCP/IP 252 stack.

After vSAN diagnostic agent 224 collects the second set of I/O aggregated statistic information and network metrics of virtual and hardware stacks associated with host-B 220A, vSAN diagnostic agent 214 is configured to obtain the second set of I/O aggregated statistic information and the network metrics of virtual and hardware stacks associated with host-B 220A from vSAN diagnostic agent 224. Block 350 may be followed by block 360.

As set forth above, the I/O request packets may be processed through virtual and physical network stacks of RDT 251, TCP/IP 253, vmk 255, vswitch 257 and vmnic 259 associated with host-A 210A. At block 360, vSAN diagnostic agent 214 is further configured to obtain network metrics of virtual and hardware stacks RDT 251, TCP/IP 253, vmk 255, vswitch 257 and vmnic 259 associated with host-A 210A. In some embodiments, the network metrics may include, but not limited to, cyclic redundance check metric, transmit carrier metric, and flapping metrics in vmnic 259 stack, duplicated addresses in vmk 255 stack, and TCP fast retransmission metric and TCP zero frame metric in TCP/IP 253 stack. Block 360 may be followed by block 370.

At block 370, vSAN diagnostic agent 214 is configured to diagnose a I/O issue associated with the object. In some embodiments, vSAN diagnostic agent 214 is configured to save the diagnosis as another object in the vSAN cluster. Therefore, other nodes in the vSAN cluster may access the diagnosis. In some embodiments, the diagnosis may be transmitted to vSAN diagnostic service 262 as diagnosis logs.

In some embodiments, in practice, a user may request to diagnose a I/O issue associated with an object (e.g., virtual machine disk assigned to VM 231) in response to VM 231 is running slow. The I/O issue diagnosis associated with the object may be performed according to example process 300 set forth above.

In some embodiments, in response to a difference between the first latency included in the first set of I/O aggregated statistic information and the third latency included in the second set of I/O aggregated statistic information exceeds a threshold, vSAN diagnostic agent 214 is configured to determine this is associated with a network latency between host-A 210A and host-B 220A. Based on the determination, vSAN diagnostic agent 214 is configured to check whether network metrics associated with host-B 220A obtained at block 350 and network metrics associated with host-A 210A include errors.

In some embodiments, vSAN diagnostic agent 214 is configured to diagnose physical hardware problems on host-A 210A in response to a cyclic redundance check value, a transmit carrier value, or a flapping frequency collected by vSAN diagnostic agent 214 exceeding a threshold. In some other embodiments, vSAN diagnostic agent 214 is configured to diagnose physical hardware problems on host-B 212A in response to a cyclic redundance check value, a transmit carrier value, or a flapping frequency collected by vSAN diagnostic agent 224 exceeding a threshold.

In some embodiments, vSAN diagnostic agent 214 is configured to diagnose a network configuration error associated with host-A 210A in response to duplicated IP addresses collected by vSAN diagnostic agent 214. In some embodiments, vSAN diagnostic agent 214 is configured to diagnose a network configuration error associated with host-B 220A in response to duplicated IP addresses collected by vSAN diagnostic agent 224.

In some embodiments, vSAN diagnostic agent 214 is configured to diagnose a network fabric utilization error or a driver issue associated with host-A 210A in response to a TCP fast retransmission greater than 1% or TCP zero frames greater than 1% collected by vSAN diagnostic agent 214. In some embodiments, vSAN diagnostic agent 214 is configured to diagnose a network fabric utilization error or a driver issue associated with host-B 220A in response to a TCP fast retransmission greater than 1% or TCP zero frames greater than 1% collected by vSAN diagnostic agent 224.

In response to that vSAN diagnostic agent 214 is unable to find errors included in network metrics associated with host-B 220A obtained at block 350 and network metrics associated with host-A 210A include errors, vSAN diagnostic agent 214 is configured to diagnose a hardware storage problem associated with SSD 218 or non-SSD 219 on host-A 210A in response to the second latency included in the first set of I/O aggregated statistic information exceeds a threshold.

In some embodiments, in response to that vSAN diagnostic agent 214 determines that the second latency is less than the threshold, vSAN diagnostic agent 214 is configured to diagnose a shortage of computation resources of a processing unit on host-A 210A.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

It will be understood that although the terms “first,” “second,” third” and so forth are used herein to describe various elements, these elements should not be limited by these terms. These terms are only used to distinguish one element from another. For example, within the scope of the present disclosure, a first element may be referred to as a second element, and similarly a second element may be referred to as a first element. As used herein, the term “and/or” includes any and all combinations of one or more of the associated listed items.

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

We claim:

1. A method for a first host to diagnose an input/output (I/O) issue associated with an object owned by the first host in a virtual storage area network (vSAN) cluster, wherein the method comprises:
identifying a first component and a second component associated with the object;
determining whether the first component is locally stored on the first host and the second component is remotely stored on a second host in the vSAN cluster;
in response to determining the first component being locally stored on the first host:
collecting a first set of I/O aggregated statistic information associated with the first component;
in response to determining the second component being remotely stored on the second host:
issuing a command to the second host;
obtaining a second set of I/O aggregated statistic information associated with the second component from the second host, wherein the second set of I/O aggregated statistic information is collected by the second host in response to the command; and
obtaining network metrics associated with the first host and the second host; and
diagnosing the I/O issue associated with the object based on the first set of I/O aggregated statistic information, the second set of I/O aggregated statistic information and the network metrics.

2. The method of claim 1, wherein the object is associated with a virtual machine disk associated to a virtual computing instance supported by the first host or another host in the vSAN cluster.

3. The method of claim 1, wherein the collecting the first set of I/O aggregated statistic information is through a pathway between a user space of the first host and a kernel space of the first host.

4. The method of claim 1, further comprising collecting timestamps and an identifier associated with the object, aggregating the timestamps and the identifier to generate the first set of I/O aggregated statistic information and saving the first set of I/O aggregated statistic information to a first trace file stored on the first host.

5. The method of claim 1, wherein the first set of I/O aggregated statistic information includes a first latency associated with the object and a second latency associated with a storage resource constraint of the first host.

6. The method of claim 1, wherein the command is through an application program interface between a first module on the first host and a second module on the second host.

7. The method of claim 1, wherein the second set of I/O information includes a third latency associated with a resource constraint of the second host.

8. The method of claim 1, wherein the network metrics are network metrics associated with a network stack between the first host and the second host.

9. The method of claim 1, wherein the I/O issue associated with the object is diagnosed as a network issue based on the network metrics.

10. The method of claim 8, wherein the I/O issue associated with the object is diagnosed as a network latency issue between the first host and the second host based on the first latency and the third latency.

11. A non-transitory computer-readable storage medium, containing a set of instructions which, in response to execution by a processor, cause the processor to perform a method for a first host to diagnose an input/output (I/O) issue associated with an object owned by the first host in a virtual storage area network (vSAN) cluster, the method comprising:
identifying a first component and a second component associated with the object;
determining whether the first component is locally stored on the first host and the second component is remotely stored on a second host in the vSAN cluster;
in response to determining the first component being locally stored on the first host:
collecting a first set of I/O aggregated statistic information associated with the first component;
in response to determining the second component being remotely stored on the second host:
issuing a command to the second host;
obtaining a second set of I/O aggregated statistic information associated with the second component from the second host, wherein the second set of I/O aggregated statistic information is collected by the second host in response to the command; and
obtaining network metrics associated with the first host and the second host; and
diagnosing the I/O issue associated with the object based on the first set of I/O aggregated statistic information, the second set of I/O aggregated statistic information and the network metrics.

12. The non-transitory computer-readable storage medium of claim 11, wherein the object is associated with a virtual machine disk associated to a virtual computing instance supported by the first host or another host in the vSAN cluster.

13. The non-transitory computer-readable storage medium of claim 11, wherein the collecting the first set of I/O aggregated statistic information is through a pathway between a user space of the first host and a kernel space of the first host.

14. The non-transitory computer-readable storage medium of claim 11, wherein the method further comprises collecting timestamps and an identifier associated with the object, aggregating the timestamps and the identifier to generate the first set of I/O aggregated statistic information and saving the first set of I/O aggregated statistic information to a first trace file stored on the first host.

15. The non-transitory computer-readable storage medium of claim 11, wherein the first set of I/O aggregated statistic information includes a first latency associated with the object and a second latency associated with a storage resource constraint of the first host.

16. The non-transitory computer-readable storage medium of claim 11, wherein the command is through an application program interface between a first module on the first host and a second module on the second host.

17. The non-transitory computer-readable storage medium of claim 11, wherein the second set of I/O information includes a third latency associated with a resource constraint of the second host.

18. The non-transitory computer-readable storage medium of claim 11, wherein the network metrics are network metrics associated with a network stack between the first host and the second host.

19. The non-transitory computer-readable storage medium of claim 11, wherein the I/O issue associated with the object is diagnosed as a network issue based on the network metrics.

20. The non-transitory computer-readable storage medium of claim 19, wherein the I/O issue associated with the object is diagnosed as a network latency issue between the first host and the second host based on the first latency and the third latency.

21. A first host to diagnose an input/output (I/O) issue associated with an object owned by the first host in a virtual storage area network (vSAN) cluster, wherein the host includes: a processor; and
a non-transitory computer-readable medium having stored thereon instructions that, in response to execution by the processor, cause the processor to:
identify a first component and a second component associated with the object;
determine whether the first component is locally stored on the first host and the second component is remotely stored on a second host in the vSAN cluster;
in response to determining the first component being locally stored on the first host:
collect a first set of I/O aggregated statistic information associated with the first component;
in response to determining the second component being remotely stored on the second host:
issue a command to the second host;
obtain a second set of I/O aggregated statistic information associated with the second component from the second host, wherein the second set of I/O aggregated statistic information is collected by the second host in response to the command; and
obtain network metrics associated with the first host and the second host; and
diagnose the I/O issue associated with the object based on the first set of I/O aggregated statistic information, the second set of I/O aggregated statistic information and the network metrics.
